(19) United States
(12) Patent Application Publication
(10) Pub. No.: US 2021/0326578 A1
(43) Pub. Date: Oct. 21, 2021

(54) FACE RECOGNITION METHOD AND APPARATUS, ELECTRONIC DEVICE, AND STORAGE MEDIUM

(71) Applicant: SHENZHEN SENSETIME TECHNOLOGY CO., LTD., Shenzhen (CN)

(72) Inventors: Lu WANG, Shenzhen (CN); Feng ZHU, Shenzhen (CN); Rui ZHAO, Shenzhen (CN)

(21) Appl. No.: 17/363,074

(22) Filed: Jun. 30, 2021

Related U.S. Application Data
(63) Continuation of application No. PCT/CN2020/088384, filed on Apr. 30, 2020.

(30) Foreign Application Priority Data
Oct. 31, 2019 (CN) 201911053929.X

(51) Int. Cl. G06K 9/00; G06K 9/62

(52) U.S. Cl. CPC G06K 9/00281; G06K 9/00228; G06K 9/6265; G06K 9/00288

(57) ABSTRACT

Some embodiments of the present disclosure relate to a method and apparatus for face recognition, an electronic device, and a storage medium. The method includes: extracting a first target parameter value of a first face image to be recognized; performing feature extraction on the first face image to obtain a first feature corresponding to the first face image; processing the first feature and the first target parameter value to obtain a first corrected feature corresponding to the first feature; and obtaining a face recognition result of the first face image based on the first corrected feature.

### CROSS-REFERENCE TO RELATED APPLICATIONS

The present application is a continuation of International Patent Application No. PCT/CN2020/088384, filed on Apr. 30, 2020, and claims priority to Chinese Patent Application No. 201911053929.X, filed on Oct. 31, 2019. The disclosures of International Patent Application No. PCT/CN2020/088384 and Chinese Patent Application No. 201911053929.X are hereby incorporated by reference in their entireties.

### BACKGROUND

A face recognition technology has been widely used in security, finance, information, education, and many other fields. Face recognition is completed based on face feature extraction and comparison. Therefore, features have a great impact on the accuracy of recognition. With the development of a deep learning technology, the accuracy of face recognition has achieved an ideal effect when a face image meets target parameter conditions, but when the face image does not meet the target parameter conditions, the accuracy of face recognition is low.

### SUMMARY

The present disclosure relates to the technical field of computer vision, and more particularly, to a method and apparatus for face recognition, an electronic device, and a storage medium.

In some embodiments of the present disclosure, a method and apparatus for face recognition, an electronic device, and a storage medium are provided.

The method for face recognition provided by some embodiments of the present disclosure may include the following operations.

A first target parameter value of a first face image to be recognized is extracted.

Feature extraction is performed on the first face image to obtain a first feature corresponding to the first face image.

The first feature and the first target parameter value are processed to obtain a first corrected feature corresponding to the first feature.

A face recognition result of the first face image is obtained based on the first corrected feature.

The apparatus for face recognition provided by some embodiments of the present disclosure may include a first extraction module, a second extraction module, a processing module and an obtaining module.

The first extraction module is configured to extract a first target parameter value of a first face image to be recognized.

The second extraction module is configured to perform feature extraction on the first face image to obtain a first feature corresponding to the first face image.

The processing module is configured to process the first feature and the first target parameter value to obtain a first corrected feature corresponding to the first feature.

The obtaining module is configured to obtain a face recognition result of the first face image based on the first corrected feature.

The electronic device provided by some embodiments of the present disclosure may include:

a processor; and

a memory configured to store instructions executable by the processor.

The processor may be configured to execute the above method.

Some embodiments of the present disclosure provide a computer-readable storage medium, which may store computer program instructions thereon. The computer program instructions may be executed by a processor to implement the above method.

It is to be understood that the above general descriptions and detailed descriptions below are only exemplary and explanatory and not intended non limit the embodiments of the present disclosure.

According to the following detailed descriptions on the exemplary embodiments with reference to the accompanying drawings, other features and aspects of the embodiments of the present disclosure become apparent.

### BRIEF DESCRIPTION OF THE DRAWINGS

The accompanying drawings, which are incorporated in and constitute a part of the specification, illustrate embodiments consistent with the present disclosure and, together with the description, serve to explain the technical solutions of the embodiments of the present disclosure.

FIG. 1 shows a flowchart of a method for face recognition according to some embodiments of the present disclosure.

FIG. 2 shows a mapping curve that maps a face angle value into an interval [0, 1] in a method for face recognition according to some embodiments of the present disclosure.

FIG. 3 shows a schematic diagram of a training process of a face recognition model in a method for face recognition according to some embodiments of the present disclosure.

FIG. 4 shows a block diagram of a face recognition apparatus according to some embodiments of the present disclosure.

FIG. 5 shows a block diagram of an electronic device 800 according to some embodiments of the present disclosure.

FIG. 6 shows a block diagram of an electronic device 1900 according to some embodiments of the present disclosure.

### DETAILED DESCRIPTION

Various exemplary embodiments, features and aspects of the embodiments of the present disclosure will be described below in detail with reference to the accompanying drawings. A same numeral in the accompanying drawings indicates a same or similar component. Although various aspects of the embodiments are illustrated in the accompanying drawings, the accompanying drawings are unnecessarily drawn according to a proportion unless otherwise specified.

As used herein, the word “exemplary” means “serving as an example, embodiment, or illustration”. Thus, any embodiment described herein as “exemplary” is not necessarily to be construed as preferred or advantageous over other embodiments.

The term “and/or” in the specification is only an association relationship for describing associated objects and represents that three relationships may exist. For example, A and/or B may represent the following three cases: only A exists, both A and B exist, and only B exists. In addition, the term “at least one type” herein represents any one of multiple types or any combination of at least two types in the multiple types, for example, at least one type of A, B and C may represent any one or multiple elements selected from a set formed by the A, the B and the C.

In addition, for describing the method for face recognition and apparatus, the electronic device and the storage medium provided by the embodiments of the present disclosure better, many specific details are presented in the following specific implementation manners. It is to be understood by those skilled in the art that the embodiments of the present disclosure may still be implemented even without some specific details. In some examples, methods, means, components and circuits known very well to those skilled in the art are not described in detail, to highlight the subject of the embodiments of the present disclosure.

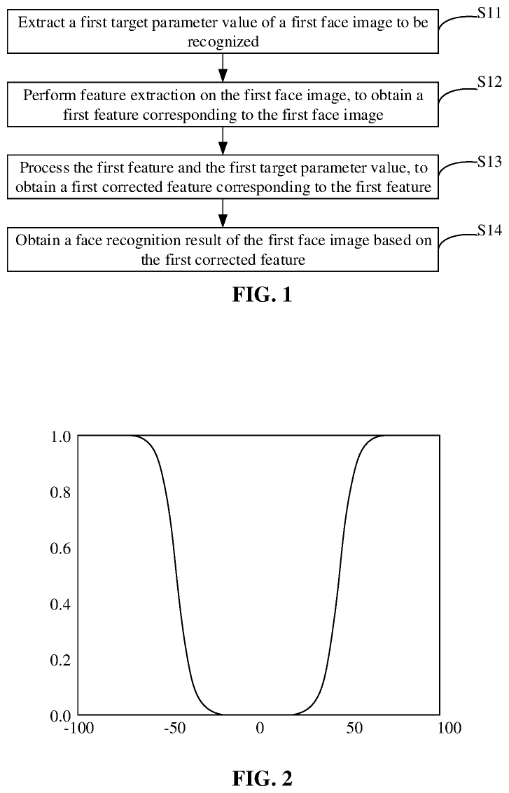

FIG. 1 shows a flowchart of a method for face recognition according to some embodiments of the present disclosure. The execution subject of the method for face recognition may be a face recognition apparatus. For example, the method for face recognition may be performed by a terminal device or a server or other processing devices. The terminal device may be a user equipment, a mobile terminal, a terminal, a cell phone, a cordless phone, a Personal Digital Assistant (PDA), a handheld device, a computing device, a vehicle-mounted device, a wearable device, etc. In some possible implementation manners, the method for face recognition may be implemented by enabling a processor to call computer-readable instructions stored in a memory. As shown in FIG. 1, the method for face recognition includes steps S11 to S14.

In step S11, a first target parameter value of a first face image to be recognized is extracted.

In some embodiments of the present disclosure, a target parameter may be any parameter that may affect the accuracy of face recognition. There may be one or more target parameters. For example, the target parameter may include one or more of a face angle, ambiguity, or an occlusion ratio. For example, the target parameter includes a face angle, which may range from −90° to 90°, where a face angle of 0° indicates a front face. As another example, the target parameter includes ambiguity, the value range of which may be [0, 1], where as the ambiguity is greater, the image is more ambiguous. As another example, the target parameter includes an occlusion ratio, the value range of which may be [0, 1], where an occlusion ratio of 0 indicates no occlusion and an occlusion ratio of 1 indicates complete occlusion.

In some examples, if the target parameter includes a face angle, the face angle values of the first face image may be extracted respectively by an open source tool such as dlib or opencv. In some examples, one or more of the pitch angle, the roll angle, and the yaw angle may be obtained. For example, the yaw angle of a face in the first face image may be obtained as a face angle value of the first face image.

In some embodiments, if the value range of the target parameter is not a preset interval, the target parameter value may be normalized to map the target parameter value into the preset interval. For example, the preset interval is [0, 1]. In some examples, the target parameter includes a face angle, the value range of which may be [−90°, 90° ], and the preset interval is [0, 1], so that the face angle values may be normalized to map the face angle values to [0, 1]. For example, a face angle value yaw may be normalized according to the equation:

$${yaw}_{norm} = \frac{1}{1 + {e}^{- ( 10 * ( \frac{\vert yaw \vert}{45.0} - 1 )}} ,$$

to obtain a normalized value yawₙₒᵣₘ corresponding to the face angle value yaw. FIG. 2 shows a mapping curve for mapping face angle values into an interval [0, 1] in a method for face recognition according to some embodiments of the present disclosure. In FIG. 2, the horizontal axis denotes the face angle value yaw, and the vertical axis denotes the normalized value yawₙₒᵣₘ corresponding to the face angle value yaw. In some examples shown in FIG. 2, when the face angle value yaw is less than 20°, it may be considered that the face is close to the front face and yawₙₒᵣₘ is close to 0; and when the face angle value yaw is greater than or equal to 50°, it may be considered as belonging to a large-angle side face and yawₙₒᵣₘ is close to 1.

In step S12, feature extraction is performed on the first face image to obtain a first feature corresponding to the first face image.

In some embodiments, the first feature corresponding to the first face image may be extracted by convolving the first face image.

In S13, the first feature and the first target parameter value are processed to obtain a first corrected feature corresponding to the first feature.

In some embodiments, the operation that the first feature and the first target parameter value are processed to obtain the first corrected feature corresponding to the first feature includes that: the first feature is processed to obtain a first residual feature corresponding to the first feature; and the first residual feature, the first target parameter value and the first feature are processed to obtain the first corrected feature corresponding to the first feature.

In the implementation manner, the first feature is processed to obtain a first residual feature corresponding to the first feature, and the first residual feature, the first target parameter value and the first feature are processed to obtain the first corrected feature corresponding to the first feature. Therefore, the correction can be performed at the feature level based on the residual.

In some examples of the implementation manner, the operation that the first feature is processed to obtain the first residual feature corresponding to the first feature includes that: full connection and activation are performed on the first feature to obtain the first residual feature corresponding to the first feature. In some examples, the full connection may be performed through a full connection layer, and the activation may be performed through an activation layer. Herein, the activation layer may employ an activation function such as a Rectified Linear Unit (ReLu) or a Parametric Rectified Linear Unit (PReLu).

In some examples, full connection and activation are performed on the first feature to obtain the first residual feature corresponding to the first feature. A more accurate corrected feature can be obtained based on the obtained first residual feature.

In some examples, the operation that full connection and activation are performed on the first feature to obtain the first residual feature corresponding to the first feature may include that: one-stage or multi-stage full connection and activation are performed on the first feature to obtain the first residual feature corresponding to the first feature. In the implementation manner, one-stage full connection and activation are performed on the first feature to obtain the first residual feature corresponding to the first feature, so that the calculation amount can be saved, and the calculation speed can be improved; and multi-stage full connection and activation are performed on the first feature to obtain the first residual feature corresponding to the first feature, which helps to obtain a more accurate corrected feature

In some examples, two stages of full connection and activation may be performed on the first feature, i.e., full connection, activation, full connection, and activation are sequentially performed on the first feature to obtain the first residual feature corresponding to the first feature.

In some examples, the dimension of the feature obtained by performing full connection on the first feature is the same as that of the first feature. In some examples, the dimension of the feature obtained by performing full connection on the first feature is the same as that of the first feature, which facilitates improving the accuracy of the obtained corrected feature.

In some embodiments of the present disclosure, the processing on the first feature is not limited to full connection and activation, but other types of processing may be performed on the first feature. For example, instead of full connection, full convolution may be performed on the first feature.

In some examples of the implementation manner, the operation that the first residual feature, the first target parameter value and the first feature are processed to obtain the first corrected feature corresponding to the first feature includes that: a first residual component corresponding to the first feature is determined according to the first residual feature and the first target parameter value; and the first corrected feature corresponding to the first feature is determined according to the first residual component and the first feature.

In some examples, the first residual component corresponding to the first feature is determined according to the first residual feature and the first target parameter value. Therefore, the first corrected feature can be determined based on the first target parameter value, so that the accuracy of face recognition of the face image which does not meet the target parameter condition is improved, and the accuracy of face recognition of the face image which meets the target parameter condition is not influenced.

In some examples, the operation that the first residual component corresponding to the first feature is determined according to the first residual feature and the first target parameter value includes that: the first residual component corresponding to the first feature is obtained according to a product of the first residual feature and a normalized value of the first target parameter value. In some examples, if the value range of the first target parameter is not a preset interval, the product of the first residual feature and a normalized value of the first target parameter value may be taken as the first residual component corresponding to the first feature. Therefore, the first residual component can be determined accurately.

In some examples, the operation that the first corrected feature corresponding to the first feature is determined according to the first residual component and the first feature includes that: the sum of the first residual component and the first feature is determined as the first corrected feature corresponding to the first feature. In some examples, the sum of the first residual component and the first feature is determined as the first corrected feature corresponding to the first feature. Therefore, the first corrected feature can be determined quickly and accurately.

In S14, a face recognition result of the first face image is obtained based on the first corrected feature.

In some embodiments, the operation that the first feature and the first target parameter value are processed includes that: the first feature and the first target parameter value are processed through an optimized face recognition model. In the implementation manner, the first feature and the first target parameter value are processed through the optimized face recognition model to obtain the first corrected feature, and face recognition is performed based on the obtained first corrected feature, so that the accuracy of face recognition can be improved.

In some embodiments, before the first feature and the first target parameter value are processed through the optimized face recognition model, the method further includes that: a second face image meeting a target parameter condition and a third face image not meeting the target parameter condition are determined according to multiple face images of any target object; feature extraction is performed on the second face image obtain a second feature corresponding to the second face image and on the third face image to obtain a third feature corresponding to the third face image; a loss function is acquired according to the second feature and the third feature; and back propagation is performed on the face recognition model based on the loss function to obtain the optimized face recognition model.

In the implementation manner, the target object may refer to an object used to train a face recognition model. There may be multiple target objects, and all face images corresponding to each target object may be face images of a same person. Each target object may correspond to multiple face images, and the multiple face images corresponding to each target object may include a face image meeting a target parameter condition and a face image not meeting the target parameter condition.

In the implementation manner, according to target parameter values of multiple face images corresponding to any target object, a second face image meeting the target parameter condition and a third face image not meeting the target parameter condition are determined from the multiple face images.

In the implementation manner, the target parameter condition may be any of the following: the target parameter value belongs to a specified interval, the target parameter value is smaller than or equal to a certain threshold, the target parameter value is larger than or equal to a certain threshold, an absolute value of the target parameter value is smaller than or equal to a certain threshold, and the absolute value of the target parameter value is larger than or equal to a certain threshold. A person skilled in the art can also set a target parameter condition flexibly according to actual application scene requirements, and some embodiments of the present disclosure do not limit this. For example, the target parameter includes a face angle, and the target parameter condition may include the absolute value of the face angle being less than an angle threshold. Herein, the angle threshold is greater than or equal to 0. As another example, the target parameter includes ambiguity, and the target parameter condition may include the ambiguity being less than an ambiguity threshold. Herein, the ambiguity threshold is greater than or equal to 0. As another example, the target parameter includes an occlusion ratio, and the target parameter condition may include the occlusion ratio being less than an occlusion ratio threshold. Herein, the occlusion ratio threshold is greater than or equal to 0.

In the implementation mode, before the second face image meeting the target parameter condition and the third face image not meeting the target parameter condition are determined according to the multiple face images of any target object, the target parameter values of the multiple face images corresponding to any target object may be obtained. In some examples, if the target parameter is a face angle, the face angle values of the multiple face images corresponding to any target object may be obtained through an open source tool such as dlib or opencv. In some examples, one or more of pitch, roll and yaw angles may be obtained. For example, the yaw angle of a face in a face image may be obtained as a face angle value of the face image.

In some examples, the operation that feature extraction is performed on the second face image obtain a second feature corresponding to the second face image and on the third face image to obtain a third feature corresponding to the third face image includes that: in the presence of multiple second face images, feature extraction is performed on the multiple second face images respectively to obtain multiple fourth features, each corresponding to a respective one of the multiple second face images; and the second feature is obtained according to the multiple fourth features.

In some examples, in the presence of multiple second face images, the second feature is obtained according to the features of the multiple second face images, thereby facilitating improving the stability of the face recognition model.

In some examples, the operation that the second feature is obtained according to the multiple fourth features includes that: an average value of the multiple fourth features is determined as the second feature. In some examples, the average value of the multiple fourth features is determined as the second feature, which facilitates further improving the stability of the face recognition model.

In another example, the operation that the second feature is obtained according to the multiple fourth features includes that: the multiple fourth features are weighted according to weights corresponding to the multiple second face images to obtain the second feature. In some examples, the weight corresponding to any second face image that meets the target parameter condition may be determined according to the target parameter value of the second face image. As the target parameter value is closer to an optimal target parameter value, the weight corresponding to the second face image is greater. For example, if the target parameter is a face angle, an optimal face angle value may be 0; if the target parameter is ambiguity, an optimal ambiguity value may be 0; and if the target parameter is an occlusion ratio, an optimal occlusion ratio value may be 0.

In some examples, the operation that feature extraction is performed on the second face image to obtain the second feature corresponding to the second face image and on the third face image to obtain the third feature corresponding to the third face image includes that: in the presence of only one second face image, feature extraction is performed on the second face image, and a feature corresponding to the second face image is taken as the second feature.

In some examples, after feature extraction is performed on the face image of the target object, the extracted features may be saved so that the saved features of the face image are reused in subsequent training without repeatedly performing feature extraction on the same face image.

In some examples, the operation that the loss function is acquired according to the second feature and the third feature includes that: the third feature and a second target parameter value of the third face image are processed through the face recognition model to obtain a second corrected feature corresponding to the third feature; and the loss function is acquired according to the second feature and the second corrected feature.

In some examples, the second corrected feature corresponding to the third feature is obtained by correcting the third feature in combination with the third feature and the second target parameter value of the third face image.

In some examples, the operation that the third feature and the second target parameter value of the third face image are processed through the face recognition model to obtain the second corrected feature corresponding to the third feature includes that: the third feature is processed through the face recognition model to obtain a second residual feature corresponding to the third feature; and the second residual feature, the second target parameter value of the third face image and the third feature are processed through the face recognition model to obtain the second corrected feature corresponding to the third feature.

In some examples, the third feature is processed through the face recognition model to obtain a second residual feature corresponding to the third feature, and the second residual feature, the second target parameter value of the third face image and the third feature are processed through the face recognition model to obtain the second corrected feature corresponding to the third feature. The face recognition model can thus be subjected to residual learning to obtain the ability to correct features.

In some examples, the operation that the third feature is processed through the face recognition model to obtain the second residual feature corresponding to the third feature includes that: full connection and activation are performed on the third feature through the face recognition model to obtain the second residual feature corresponding to the third feature. In some examples, full connection and activation are performed on the third feature through the face recognition model to obtain the second residual feature corresponding to the third feature. A more accurate corrected feature can be obtained based on the thus obtained second residual feature.

In the implementation manner, it is not limited to full connection and activation of the third feature by the face recognition model, but other types of processing of the third feature may be performed by the face recognition model. For example, full convolution processing instead of full connection may be performed on the third feature through the face recognition model.

In some examples, the operation that full connection and activation are performed on the third feature through the face recognition model to obtain the second residual feature corresponding to the third feature includes that: one-stage or multi-stage full connection and activation are performed on the third feature through the face recognition model to obtain the second residual feature corresponding to the third feature.

In some examples, one-stage full connection and activation are performed on the third feature through the face recognition model to obtain the second residual feature corresponding to the third feature, so that the calculation amount can be saved, and the calculation speed can be improved; and multi-stage full connection and activation are performed on the third feature through the face recognition model to obtain the second residual feature corresponding to the third feature, which facilitates improving the performance of the face recognition model.

In some examples, two stages of full connection and activation may be performed on the third feature through the face recognition model, i.e., full connection, activation, full connection, and activation are sequentially performed on the third feature through the face recognition model to obtain the second residual feature corresponding to the third feature.

In some examples, the dimension of the feature obtained by performing full connection on the third feature is the same as that of the third feature. In some examples, the dimension of the feature obtained by performing full connection on the third feature is the same as that of the third feature, which helps to guarantee the performance of the trained face recognition model.

In some examples, the operation that the second residual feature, the second target parameter value of the third face image and the third feature are processed through the face recognition model to obtain the second corrected feature corresponding to the third feature includes: a second residual component corresponding to the third feature is determined through the face recognition model according to the second residual feature and the second target parameter value; and the second corrected feature corresponding to the third feature is determined through the face recognition model according to the second residual component and the third feature.

In some examples, the second residual component corresponding to the third feature is determined through the face recognition model according to the second residual feature and the second target parameter value. Therefore, the second corrected feature can be determined based on the second target parameter value, so that the accuracy of face recognition of the face image which does not meet the target parameter condition is improved by the trained face recognition model, while the accuracy of face recognition of the face image which meets the target parameter condition is not influenced.

In some examples, the operation that the second residual component corresponding to the third feature is determined through the face recognition model according to the second residual feature and the second target parameter value includes that: the second residual component corresponding to the third feature is obtained through the face recognition model according to a product of the second residual feature and a normalized value of the second target parameter value. In some examples, if the value range of the second target parameter is not a preset interval, the product of the second residual feature and a normalized value of the second target parameter value may be taken as the second residual component corresponding to the third feature. Therefore, the second residual component can be determined accurately.

In some other examples, the operation that the second residual component corresponding to the third feature is determined through the face recognition model according to the second residual feature and the second target parameter value includes that: the second residual component corresponding to the third feature is obtained by determining the product of the second residual feature and the second target parameter value through the face recognition model. In some examples, if the value range of the second target parameter is equal to a preset interval, the product of the second residual feature and the second target parameter value may be taken as the second residual component corresponding to the third feature.

In some examples, the operation that the second corrected feature corresponding to the third feature is determined through the face recognition model according to the second residual component and the third feature includes that: a sum of the second residual component and the third feature is determined as the second corrected feature corresponding to the third feature through the face recognition model. In some examples, the sum of the second residual component and the third feature is determined as the second corrected feature corresponding to the third feature through the face recognition model. Therefore, the second corrected feature can be determined quickly and accurately.

In the implementation manner, the training objective of the face recognition model is to approach the second corrected feature corresponding to the third feature to the second feature. Therefore, In some examples, the operation that the loss function is acquired according to the second feature and the second corrected feature includes that: the loss function is determined according to a difference between the second corrected feature and the second feature. For example, a square of the difference between the second corrected feature and the second feature may be determined as the value of the loss function.

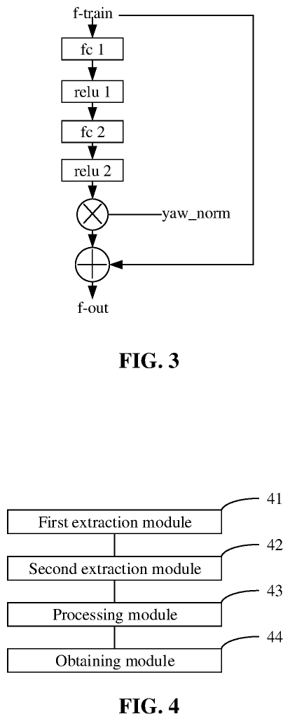

FIG. 3 shows a schematic diagram of a process of training a face recognition model in a method for face recognition according to some embodiments of the present disclosure. In some examples shown in FIG. 3, the target parameter is a face angle, and the third feature (f_train) is sequentially subjected to full connection (fc 1), activation (relu 1), full connection (fc 2) and activation (relu 2) through the face recognition model to obtain the second residual feature corresponding to the third feature. The product of the second residual feature and a normalized value (yaw_norm) of the second target parameter value (yaw) of the third face image is determined through the face recognition model to obtain the second residual component corresponding to the third feature. The sum of the second residual component and the third feature is determined as the second corrected feature (f_out) corresponding to the third feature through the face recognition model. In some examples, the target parameter is a face angle, when the face angle value is smaller than 20°, the second corrected feature corresponding to the third feature is close to the third feature; and when the face angle value is greater than 50°, the second residual component is no longer close to 0, and thus the third feature is corrected.

In the implementation manner, the face recognition model performs correction at the feature level, i.e. no corrected image is needed (e.g. no corrected image of the third face image is needed), and only the corrected feature needs to be obtained. Therefore, noise introduced in the process of obtaining the corrected image can be avoided, thereby facilitating further improving the accuracy of face recognition.

A parameter converged face recognition model trained according to the above implementation manner can correct the feature of the face image which does not meet the target parameter condition into the feature which meets the target parameter condition, so that the accuracy of face recognition of the face image which does not meet the target parameter condition can be improved.

In some embodiments of the present disclosure, as the distance between the target parameter value of the first face image to be recognized and the optimal target parameter value is smaller, the first corrected feature corresponding to the first feature is closer to the first feature; and as the distance between the target parameter value of the first face image and the optimal target parameter value is larger, the difference between the first corrected feature corresponding to the first feature and the first feature is larger. Therefore, the method for face recognition provided by some embodiments of the present disclosure is beneficial to improving the accuracy of face recognition of the face image which does not meet the target parameter condition, while the accuracy of face recognition of the face image which meets the target parameter condition is not influenced.

It is to be understood that the method embodiments mentioned in the embodiments of the present disclosure may be combined with each other to form a combined embodiment without departing from the principle and logic, which is not elaborated in the embodiments of the present disclosure for the sake of simplicity.

It may be understood by the person skilled in the art that in the method of the specific implementation manners, the writing sequence of each step does not mean a strict execution sequence to form any limit to the implementation process, and the specific execution sequence of each step may be determined in terms of the function and possible internal logic.

In addition, some embodiments of the present disclosure also provide a face recognition apparatus, an electronic device, a computer-readable storage medium and a program, which may be used for implementing any method for face recognition provided by some embodiments of the present disclosure, and the corresponding technical solution and description are referred to the corresponding description of the method part. The descriptions are omitted herein.

FIG. 4 shows a block diagram of a face recognition apparatus according to some embodiments of the present disclosure. As shown in FIG. 4, the face recognition apparatus includes: a first extraction module 41, configured to extract a first target parameter value of a first face image to be recognized; a second extraction module 42, configured to perform feature extraction on the first face image to obtain a first feature corresponding to the first face image; a processing module 43, configured to process the first feature and the first target parameter value to obtain a first corrected feature corresponding to the first feature; and an obtaining module 44, configured to obtain a face recognition result of the first face image based on the first corrected feature.

In some embodiments, the obtaining module 44 is configured to: process the first feature to obtain a first residual feature corresponding to the first feature; and process the first residual feature, the first target parameter value and the first feature to obtain the first corrected feature corresponding to the first feature.

In some embodiments, the obtaining module 44 is configured to: perform full connection and activation on the first feature to obtain the first residual feature corresponding to the first feature.

In some embodiments, the obtaining module 44 is configured to: perform one-stage or multi-stage full connection and activation on the first feature to obtain the first residual feature corresponding to the first feature.

In some embodiments, a dimension of the feature obtained by performing full connection on the first feature is the same as that of the first feature.

In some embodiments, the obtaining module 44 is configured to: determine a first residual component corresponding to the first feature according to the first residual feature and the first target parameter value; and determine the first corrected feature corresponding to the first feature according to the first residual component and the first feature.

In some embodiments, the obtaining module 44 is configured to: obtain the first residual component corresponding to the first feature according to a product of the first residual feature and a normalized value of the first target parameter value.

In some embodiments, the obtaining module 44 is configured to: determine the sum of the first residual component and the first feature as the first corrected feature corresponding to the first feature.

In some embodiments, a target parameter includes a face angle, ambiguity, or an occlusion ratio.

In some embodiments, the processing module 43 is configured to: process the first feature and the first target parameter value through an optimized face recognition model.

In some embodiments, the apparatus further includes: a determination module, configured to determine a second face image meeting a target parameter condition and a third face image not meeting the target parameter condition according to multiple face images of any target object; a third extraction module, configured to perform feature extraction on the second face image to obtain a second feature corresponding to the second face image, and perform feature extraction on the third face image to obtain a third feature corresponding to the third face image; an acquisition module, configured to acquire a loss function according to the second feature and the third feature; and an optimization module, configured to perform back propagation on the face recognition model based on the loss function to obtain the optimized face recognition model.

In some embodiments, the acquisition module 44 is configured to: process the third feature and a second target parameter value of the third face image through the face recognition model to obtain a second corrected feature corresponding to the third feature; and acquire the loss function according to the second feature and the second corrected feature.

In some embodiments, the acquisition module 44 is configured to: process the third feature through the face recognition model to obtain a second residual feature corresponding to the third feature; and process the second residual feature, the second target parameter value of the third face image and the third feature through the face recognition model to obtain the second corrected feature corresponding to the third feature.

In some embodiments, the acquisition module 44 is configured to: perform full connection and activation on the third feature through the face recognition model to obtain the second residual feature corresponding to the third feature.

In some embodiments, the acquisition module 44 is configured to: process one-stage or multi-stage full connection and activation on the third feature through the face recognition model to obtain the second residual feature corresponding to the third feature.

In some embodiments, the dimension of the feature obtained by performing full connection on the third feature is the same as that of the third feature.

In some embodiments, the acquisition module 44 is configured to: determine a second residual component corresponding to the third feature through the face recognition model according to the second residual feature and the second target parameter value; and determine the second corrected feature corresponding to the third feature through the face recognition model according to the second residual component and the third feature.

In some embodiments, the acquisition module 44 is configured to: obtain the second residual component corresponding to the third feature through the face recognition model according to a product of the second residual feature and a normalized value of the second target parameter value.

In some embodiments, the acquisition module 44 is configured to: determine a sum of the second residual component and the third feature as the second corrected feature corresponding to the third feature through the face recognition model.

In some embodiments, the third extraction module is configured to: perform, in the presence of multiple second face images, feature extraction on the multiple second face images respectively to obtain multiple fourth features, each corresponding to a respective one of the multiple second face images; and obtain the second feature according to the multiple fourth features.

In some embodiments, the third extraction module is configured to: determine an average value of the multiple fourth features as the second feature.

In some embodiments, the acquisition module 44 is configured to: determine the loss function according to a difference between the second corrected feature and the second feature.

In some embodiments, the functions or modules contained in the apparatus provided in some embodiments of the present disclosure may be configured to perform the methods described in the above method embodiments. The specific implementation may refer to the description of the above method embodiments. For brevity, descriptions are omitted herein.

Some embodiments of the present disclosure also provide a computer-readable storage medium, which stores computer program instructions thereon. The computer program instructions are executed by a processor to implement the above method. The computer-readable storage medium may be a non-volatile computer-readable storage medium.

Some embodiments of the present disclosure also provide an electronic device, which includes: a processor; and a memory configured to store instructions executable by the processor, the processor being configured to execute the above method.

The electronic device may be provided as a terminal, a server or other types of devices.

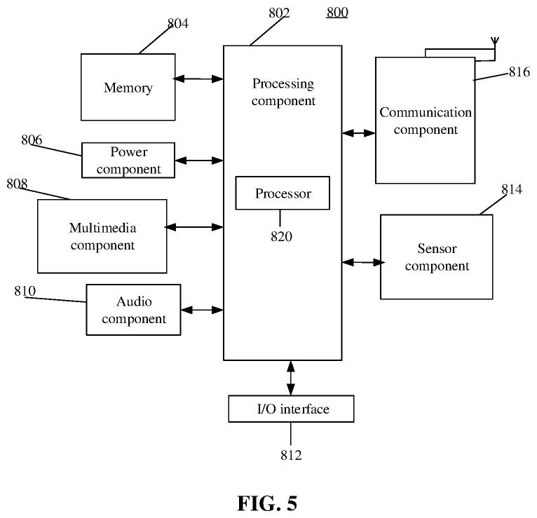

FIG. 5 shows a block diagram of an electronic device 800 according to some embodiments of the present disclosure. For example, the electronic device 800 may be a terminal such as a mobile phone, a computer, a digital broadcast terminal, a messaging device, a gaming console, a tablet, a medical device, exercise equipment, and a PDA.

Referring to FIG. 5, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For example, the processing component 802 may include a multimedia module to facilitate the interaction between the multimedia component 808 and the processing component 802.

The memory 804 is configured to store various types of data to support the operation of the electronic device 800. Examples of such data include instructions for any applications or methods operated on the electronic device 800, contact data, phonebook data, messages, pictures, video, etc. The memory 804 may be implemented by using any type of volatile or non-volatile memory devices, or a combination thereof, such as a Static Random Access Memory (SRAM), an Electrically Erasable Programmable Read Only Memory (EEPROM), an Electrical Programmable Read Only Memory (EPROM), a Programmable Read-Only Memory (PROM), a Read-Only Memory (ROM), a magnetic memory, a flash memory, a magnetic or optical disk.

The power component 806 provides power to various components of the electronic device 800. The power component 806 may include a power management system, one or more power sources, and any other components associated with the generation, management and distribution of power in the electronic device 800.

The multimedia component 808 includes a screen providing an output interface between the electronic device 800 and the user. In some embodiments, the screen may include a Liquid Crystal Display (LCD) and a Touch Pad (TP). If the screen includes the TP, the screen may be implemented as a touch screen to receive input signals from the user. The TP includes one or more touch sensors to sense touches, swipes and gestures on the TP. The touch sensors may not only sense a boundary of a touch or swipe action, but also sense a period of time and a pressure associated with the touch or swipe action. In some embodiments, the multimedia component 808 includes a front camera and/or a rear camera. The front camera and/or the rear camera may receive an external multimedia datum while the electronic device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a Microphone (MIC) configured to receive an external audio signal when the electronic device 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as a keyboard, a click wheel, or buttons. The buttons may include, but are not limited to, a home button, a volume button, a starting button, and a locking button.

The sensor component 814 includes one or more sensors to provide status assessments of various aspects of the electronic device 800. For example, the sensor component 814 may detect an open/closed status of the electronic device 800, and relative positioning of components. For example, the component is the display and the keypad of the electronic device 800. The sensor component 814 may also detect a change in position of the electronic device 800 or a component of the electronic device 800, a presence or absence of user contact with the electronic device 800, an orientation or an acceleration/deceleration of the electronic device 800, and a change in temperature of the electronic device 800. The sensor component 814 may include a proximity sensor configured to detect the presence of nearby objects without any physical contact. The sensor component 814 may also include a light sensor, such as a Complementary Metal Oxide Semiconductor (CMOS) or Charge Coupled Device (CCD) image sensor, for use in imaging applications. In some embodiments, the sensor component 814 may also include an acceleration sensor, a gyroscope sensor, a magnetic sensor, a pressure sensor, or a temperature sensor.

The communication component 816 is configured to facilitate communication, wired or wirelessly, between the electronic device 800 and other devices. The electronic device 800 may access a wireless network based on a communication standard, such as WiFi, 2G or 3G, or a combination thereof. In some embodiments, the communication component 816 receives a broadcast signal or broadcast associated information from an external broadcast management system via a broadcast channel In some embodiments, the communication component 816 further includes a Near Field Communication (NFC) module to facilitate short-range communications. For example, the NFC module may be implemented based on a Radio Frequency Identification (RFID) technology, an Infrared Data Association (IrDA) technology, an Ultra Wide Band (UWB) technology, a Bluetooth (BT) technology, and other technologies.

In some embodiments, the electronic device 800 may be implemented with one or more Application Specific Integrated Circuits (ASICs), Digital Signal Processors (DSPs), Digital Signal Processing Devices (DSPD), Programmable Logic Devices (PLDs), Field Programmable Gate Arrays (FPGAs), controllers, micro-controllers, microprocessors, or other electronic elements, for performing the above described methods.

In some embodiments, a non-volatile computer-readable storage medium, for example, a memory 804 including computer program instructions, is also provided. The computer program instructions may be executed by a processor 820 of an electronic device 800 to implement the above-mentioned method.

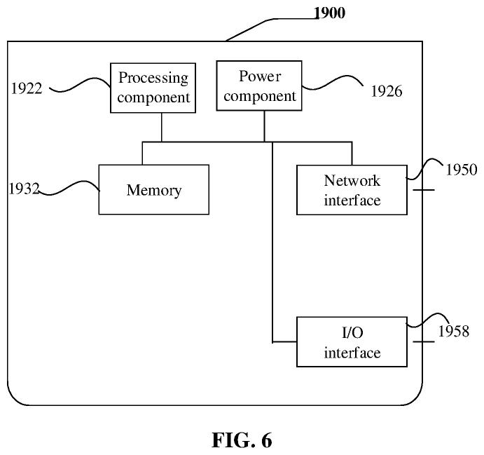

FIG. 6 shows a block diagram of another electronic device 1900 according to some embodiments of the present disclosure. For example, the electronic device 1900 may be provided as a server. Referring to FIG. 6, the electronic device 1900 includes a processing component 1922, further including one or more processors, and a memory resource represented by a memory 1932, configured to store instructions executable by the processing component 1922, for example, an application program. The application program stored in the memory 1932 may include one or more modules, with each module corresponding to one group of instructions. In addition, the processing component 1922 is configured to execute the instructions to execute the above-mentioned method.

The electronic device 1900 may further include a power component 1926 configured to execute power management of the electronic device 1900, a wired or wireless network interface 1950 configured to connect the electronic device 1900 to a network and an I/O interface 1958. The electronic device 1900 may be operated based on an operating system stored in the memory 1932, for example, Windows Server™, Mac OS X™, Unix™, Linux™, FreeBSD™ or the like.

In some embodiments, a non-volatile computer-readable storage medium, for example, a memory 1932 including computer program instructions, is also provided. The computer program instructions may be executed by a processing component 1922 of an electronic device 1900 to implement the above-mentioned method.

Some embodiments of the present disclosure may be a system, a method and/or a computer program product. The computer program product may include a computer-readable storage medium, in which computer-readable program instructions configured to enable a processor to implement each aspect of some embodiments of the present disclosure is stored.

The computer-readable storage medium may be a physical device capable of retaining and storing instructions used by instructions execution device. The computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a ROM, an EPROM (or a flash memory), an SRAM, a Compact Disc Read-Only Memory (CD-ROM), a Digital Video Disc (DVD), a memory stick, a floppy disk, a mechanical coding device, a punched card or in-slot raised structure with instructions stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instructions described here may be downloaded from the computer-readable storage medium to each computing/processing device or downloaded to an external computer or an external storage device through a network such as an Internet, a Local Area Network (LAN), a Wide Area Network (WAN) and/or a wireless network. The network may include a copper transmission cable, an optical fiber transmission cable, a wireless transmission cable, a router, a firewall, a switch, a gateway computer and/or an edge server. A network adapter card or network interface in each computing/processing device receives the computer-readable program instructions from the network and forwards the computer-readable program instructions for storage in the computer-readable storage medium in each computing/processing device.

The computer program instructions configured to execute the operations of some embodiments of the present disclosure may be assembly instructions, Instruction Set Architecture (ISA) instructions, machine instructions, machine related instructions, microcode, firmware instructions, state setting data or a source code or target code edited by one or any combination of more programming languages, the programming language including an object-oriented programming language such as Smalltalk and C++ and a conventional procedural programming language such as “C” language or a similar programming language. The computer-readable program instructions may be completely or partially executed in a computer of a user, executed as an independent software package, executed partially in the computer of the user and partially in a remote computer, or executed completely in the remote server or a server. In a case involved in the remote computer, the remote computer may be connected to the user computer via an type of network including the LAN or the WAN, or may be connected to an external computer (such as using an Internet service provider to provide the Internet connection). In some embodiments, an electronic circuit, such as a programmable logic circuit, an FPGA or a Programmable Logic Array (PLA), is customized by using state information of the computer-readable program instructions. The electronic circuit may execute the computer-readable program instructions to implement each aspect of some embodiments of the present disclosure.

Herein, each aspect of some embodiments of the present disclosure is described with reference to flowcharts and/or block diagrams of the method, device (system) and computer program product according to some embodiments of the present disclosure. It is to be understood that each block in the flowcharts and/or the block diagrams and a combination of each block in the flowcharts and/or the block diagrams may be implemented by computer-readable program instructions.

These computer-readable program instructions may be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner, so that the computer-readable medium including the instructions includes a product including instructions for implementing each aspect of the function/action specified in one or more blocks in the flowcharts and/or the block diagrams.

These computer-readable program instructions may further be loaded to the computer, the other programmable data processing device or the other device, so that a series of operating steps are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate probably implemented system architectures, functions and operations of the system, method and computer program product according to multiple embodiments of the present disclosure. On the aspect, each block in the flowcharts or the block diagrams may represent part of a module, a program segment or instructions, and part of the module, the program segment or the instructions include one or more executable instructions configured to realize a specified logical function. In some alternative implementations, the functions marked in the blocks may also be realized in a sequence different from those marked in the drawings. For example, two continuous blocks may actually be executed in a substantially concurrent manner and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and computer instructions.

Each embodiment of the present disclosure has been described above. The above descriptions are exemplary, non-exhaustive and also not limited to each disclosed embodiment. Many modifications and variations are apparent to those of ordinary skill in the art without departing from the scope and spirit of each described embodiment of the present disclosure. The terms used herein are selected to explain the principle and practical application of each embodiment or technical improvements in the technologies in the market best or enable others of ordinary skill in the art to understand each embodiment disclosed herein.

### INDUSTRIAL APPLICABILITY

Some embodiments of the present disclosure relate to a method and apparatus for face recognition, an electronic device, and a storage medium. The method includes: extracting a first target parameter value of a first face image to be recognized; performing feature extraction on the first face image to obtain a first feature corresponding to the first face image; processing the first feature and the first target parameter value to obtain a first corrected feature corresponding to the first feature; and obtaining a face recognition result of the first face image based on the first corrected feature. In some embodiments of the present disclosure, the feature of a face image can be corrected, so that the accuracy of face recognition can be improved.

1. A method for face recognition, comprising:
extracting a value of a target parameter of a first face image to be recognized as a first target parameter value;
performing feature extraction on the first face image to obtain a first feature corresponding to the first face image;
processing the first feature and the first target parameter value to obtain a first corrected feature corresponding to the first feature; and
obtaining a face recognition result of the first face image based on the first corrected feature.

2. The method according to claim 1, wherein processing the first feature and the first target parameter value to obtain the first corrected feature corresponding to the first feature comprises:
processing the first feature to obtain a first residual feature corresponding to the first feature; and
processing the first residual feature, the first target parameter value, and the first feature, to obtain the first corrected feature corresponding to the first feature.

3. The method according to claim 2, wherein processing the first feature to obtain the first residual feature corresponding to the first feature comprises:
performing full connection and activation on the first feature to obtain the first residual feature corresponding to the first feature.

4. The method according to claim 3, wherein performing full connection and activation on the first feature to obtain the first residual feature corresponding to the first feature comprises:
performing one-stage or multi-stage full connection and activation on the first feature to obtain the first residual feature corresponding to the first feature,
wherein a dimension of the feature obtained by performing full connection on the first feature is the same as that of the first feature.

5. The method according to claim 2, wherein processing the first residual feature, the first target parameter value and the first feature to obtain the first corrected feature corresponding to the first feature comprises:
determining a first residual component corresponding to the first feature according to the first residual feature and the first target parameter value; and
determining the first corrected feature corresponding to the first feature according to the first residual component and the first feature.

6. The method according to claim 5, wherein determining a first residual component corresponding to the first feature according to the first residual feature and the first target parameter value comprises:
obtaining the first residual component corresponding to the first feature according to a product of the first residual feature and a normalized value of the first target parameter value, and
wherein determining the first corrected feature corresponding to the first feature according to the first residual component and the first feature comprises:
determining a sum of the first residual component and the first feature as the first corrected feature corresponding to the first feature.

7. The method according to claim 1, wherein the target parameter comprises a face angle, ambiguity, or an occlusion ratio, and
wherein processing the first feature and the first target parameter value comprises:
processing the first feature and the first target parameter value through an optimized face recognition model.

8. The method according to claim 7, wherein before processing the first feature and the first target parameter value through the face recognition model, the method further comprises:
determining a second face image meeting a target parameter condition and a third face image not meeting the target parameter condition according to a plurality of face images of a target object;
performing feature extraction on the second face image to obtain a second feature corresponding to the second face image, and performing feature extraction on the third face image to obtain a third feature corresponding to the third face image;
acquiring a loss function according to the second feature and the third feature; and
performing back propagation on the face recognition model based on the loss function, to obtain an optimized face recognition model.

9. The method according to claim 8, wherein acquiring the loss function according to the second feature and the third feature comprises:
processing the third feature and a second target parameter value, which is a value of the target parameter of the third face image, through the face recognition model, to obtain a second corrected feature corresponding to the third feature; and
acquiring the loss function according to the second feature and the second corrected feature.

10. The method according to claim 9, wherein processing the third feature and the second target parameter value of the third face image through the face recognition model, to obtain the second corrected feature corresponding to the third feature comprises:
processing the third feature through the face recognition model to obtain a second residual feature corresponding to the third feature; and
processing the second residual feature, the second target parameter value of the third face image, and the third feature through the face recognition model to obtain the second corrected feature corresponding to the third feature.

11. The method according to claim 10, wherein processing the third feature through the face recognition model to obtain the second residual feature corresponding to the third feature comprises:
performing full connection and activation on the third feature through the face recognition model, to obtain the second residual feature corresponding to the third feature.

12. The method according to claim 11, wherein performing full connection and activation on the third feature through the face recognition model to obtain the second residual feature corresponding to the third feature comprises:
performing one-stage or multi-stage full connection and activation on the third feature through the face recognition model, to obtain the second residual feature corresponding to the third feature.

13. The method according to claim 11, wherein a dimension of the feature obtained by performing full connection on the third feature is the same as that of the third feature.

14. The method according to claim 10, wherein processing the second residual feature, the second target parameter value of the third face image, and the third feature through the face recognition model to obtain the second corrected feature corresponding to the third feature comprises:
determining a second residual component corresponding to the third feature through the face recognition model according to the second residual feature and the second target parameter value; and
determining the second corrected feature corresponding to the third feature through the face recognition model according to the second residual component and the third feature.

15. The method according to claim 14, wherein determining the second residual component corresponding to the third feature through the face recognition model according to the second residual feature and the second target parameter value comprises:
obtaining the second residual component corresponding to the third feature through the face recognition model according to a product of the second residual feature and a normalized value of the second target parameter value.

16. The method according to claim 14, wherein determining the second corrected feature corresponding to the third feature through the face recognition model according to the second residual component and the third feature comprises:
determining a sum of the second residual component and the third feature as the second corrected feature corresponding to the third feature through the face recognition model.

17. The method according to claim 8, wherein the second face image comprises a plurality of second face images, and performing feature extraction on the second face image to obtain the second feature corresponding to the second face image, and performing feature extraction on the third face image to obtain the third feature corresponding to the third face image comprises:
performing feature extraction on the plurality of second face images respectively, to obtain a plurality of fourth features, each corresponding to a respective one of the plurality of second face images; and
obtaining the second feature according to the plurality of fourth features.

18. The method according to claim 17, wherein obtaining the second feature according to the plurality of fourth features comprises:
determining an average value of the plurality of fourth features as the second feature.

19. The method according to claim 9, wherein acquiring the loss function according to the second feature and the second corrected feature comprises:
determining the loss function according to a difference between the second corrected feature and the second feature.

20. An electronic device, comprising:
a processor; and
a memory configured to store instructions executable by the processor,
wherein the processor is configured to execute a method for face recognition, the method comprising:
extracting a value of a target parameter of a first face image to be recognized as a first target parameter value;
performing feature extraction on the first face image to obtain a first feature corresponding to the first face image;
processing the first feature and the first target parameter value to obtain a first corrected feature corresponding to the first feature; and
obtaining a face recognition result of the first face image based on the first corrected feature.
